(19) United States
(12) Patent Application Publication
(10) Pub. No.: US 2013/0257749 A1
(43) Pub. Date: Oct. 3, 2013

(54) SYSTEMS AND METHODS FOR NAVIGATING CONTENT ON A USER EQUIPMENT HAVING A MULTI-REGION TOUCH SENSITIVE DISPLAY

(71) Applicants: Thomas Steven Woods, Arlington Heights, IL (US); Michael R. Nichols, La Canada Flintridge, CA (US)

(72) Inventors: Thomas Steven Woods, Arlington Heights, IL (US); Michael R. Nichols, La Canada Flintridge, CA (US)

(73) Assignee: UNITED VIDEO PROPERTIES, INC., Santa Clara, CA (US)

(21) Appl. No.: 13/437,527

(22) Filed: Apr. 2, 2012

(51) Int. Cl. G06F 3/0488

(52) U.S. Cl. CPC G06F 3/0488
USPC 345/173

(57) ABSTRACT

Systems and methods are provided for navigating media content information using a media guidance application implemented on a portable device with a touch-sensitive display. A touch-sensitive display screen with at least two portions is displayed. The first portion is dedicated to receive handwritten input. The second portion is dedicated to display an interactive media guide and receive navigation direction input or selection input. Upon receiving handwritten input on the first portion of the touch-sensitive display, the device displays a media content corresponding to the received handwritten input in the media guide of the second portion of the touch-sensitive device.

### BACKGROUND

Traditional tablet applications allow a user to navigate media guide listings by scrolling up, down, right or left using multiple finger strokes. With the sheer volume of content present in today's media guides, such a method of navigating media guide listings is very repetitive and tedious. The user must scroll through several channels for different times to find a desired media asset. The user must repeat such tedious navigation every time he wishes to find a different desired media asset.

Traditional tablet applications are typically configured to recognize the direction in which the user scrolls the media guide. A tablet that is configured to only receive a navigation direction input limits the user's ability to efficiently browse the media guide. Thus, traditional systems fail to provide the user with an interface to efficiently navigate the media guide to locate desired content.

### SUMMARY

In view of the foregoing, methods and systems for providing media content guidance on a touch-sensitive device are provided. The systems and methods described below include techniques for navigating media information using a media guidance application implemented on a device with a touch-sensitive display.

In several embodiments of the present invention, a first portion of the touch-sensitive display may be dedicated to receiving handwritten input. A portion of the touch-sensitive display can be referred to as a subregion of the display. A second portion of the touch-sensitive display may be dedicated to displaying interactive media guide listings and receiving only navigation direction or selection inputs to browse the media guide. In some embodiments, the handwritten input on the first portion of the touch-sensitive display may generate a search through the interactive media guide displayed on the second portion of the touch-sensitive display. In some embodiments, a third portion may be dedicated to displaying a video of a media asset and may be configured to receive different types of user inputs to control playback and display of the media asset.

In some embodiments, the user may issue a command by entering a handwritten input on one portion of the touch-sensitive display. The touch-sensitive device processes this command and performs the action based on the command. In some embodiments, these issued commands processed from the handwritten input lead to functions being performed on a second portion of the touch-sensitive display.

In some embodiments, the user may navigate the interactive media guide on the touch-screen device by providing touch input and selecting media assets to display on another portion of the touch-screen device. In some embodiments, the user may also be allowed to control the playback of such displayed media assets.

In some embodiments, the user may display an advertisement on the third portion of the touch-screen device by entering handwritten input on the first portion of the touch-screen device.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings and other media guidance information in accordance with various embodiments of the invention;

FIG. 2 shows another illustrative display screen that may be used to provide media guidance application listings in accordance with various embodiments of the invention;

FIG. 3 shows a block diagram of a touch-sensitive device in accordance with various embodiments of the invention;

FIG. 4 shows a block diagram of a cross-platform interactive media system in accordance with various embodiments of the invention;

FIG. 5 shows a simplified block diagram of an interactive media system in accordance with various embodiments of the invention;

FIG. 6 shows the various regions of a touch-sensitive device in accordance with various embodiments of the invention;

FIG. 7 shows an illustrative command table that associates different types of handwritten input with corresponding media guidance functions in accordance with various embodiments of the invention;

FIG. 8 shows an illustrative display screen before receiving handwritten input in accordance with an embodiment of the invention;

FIG. 9 shows another illustrative display screen after receiving handwritten input in accordance with an embodiment of the invention;

FIG. 10 shows an illustrative flow diagram depicting an exemplary process for receiving and responding to different types of user input in the various portions of the touch-sensitive display device in accordance with various embodiments of the invention;

FIG. 11 shows an illustrative display screen for receiving handwritten input of an advertisement in accordance with an embodiment of the invention; and

FIG. 12 shows another illustrative display screen after receiving handwritten input in accordance with an embodiment of the invention.

### DETAILED DESCRIPTION OF EMBODIMENTS

Traditional tablet applications allow a user to navigate a media guide by scrolling up, down, right or left to manually search for a desired content from the plethora of available media content. This invention may be targeted to allow the user to navigate a media guide on a touch-sensitive device more efficiently by allowing the user to input different types of touch input.

The touch-sensitive screen of the touch-sensitive device may be divided into several portions. Each portion of the touch-sensitive screen may be configured to receive different types of user touch input. Once the touch-sensitive device determines that it has received a user touch input, it may determine which portion of the touch-sensitive screen received the touch-sensitive input. After the device makes such a determination, it may determine what types of inputs that portion of the touch-sensitive screen is configured to receive. Subsequently, the device may process the touch input in a specific manner associated with the type of input that portion of the device is configured to receive. After processing the user input, the device may proceed to implement the media guidance application function directed by the user touch input.

In accordance with an embodiment of the present invention, users may navigate among and locate media content using a touch-sensitive device running a media guidance application. The media guidance application may be any suitable software application, e.g., running on a processor within the touch-sensitive device. For example, the media guidance application may be or include a JAVA applet executable on a mobile device. JAVA is a registered trademark owned by Sun Microsystems, Inc. More generally, the media guidance application may be, include, or be part of an application, a software module, or other suitable set of computer-readable instructions.

The media guidance application may also be referred to, in some instances, as an “app.” In an embodiment, the media guidance application may execute remotely, e.g., on a processor located in one or more servers, and the results may be transmitted to, and displayed on, the touch-sensitive device. Generally, the media guidance application may be provided as an on-line application (i.e., provided on a web-site), a stand-alone application or client, or as a distributed application capable of running on multiple processors or devices.

In addition to search and identification functions, media guidance applications may also be used to view, store, transmit, or otherwise interact with the media content. For example, after locating a media asset of interest, a user may use the media guidance application to stream the media asset over the internet. It should be understood that media applications running on a touch-sensitive device may perform any or all of the functions typically performed by media guidance applications running on television sets or set-top boxes. For example, a user may interact with a touch-sensitive device running a media guidance application to select television programs for recording using a digital video recorder (DVR), e.g., connected to a television. In addition, using these touch-sensitive devices, users are able to navigate among and locate the same media generally accessible through a television, computer system, or other suitable media device.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

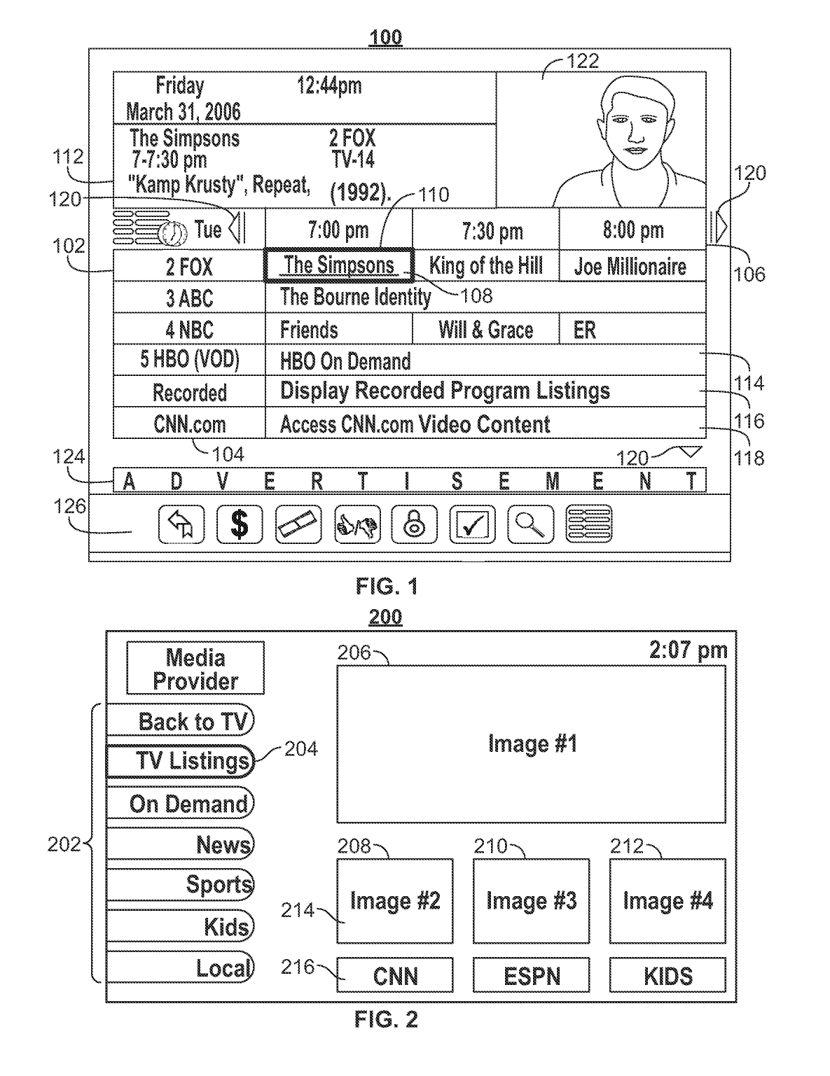

FIGS. 1-2, 8-9, and 11-12 show illustrative display screens that may be used to provide media guidance data. The display screens shown in FIGS. 1-2, 8-9, and 11-12 may be implemented on any suitable user equipment device or platform. While the displays of FIGS. 1-2, 8-9, and 11-12 are illustrated as full-screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid media listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of media listings, such as media listing 108, where each listing provides the title of the media asset provided on the listing's associated channel and time. With a user input device, a user can select media listings by moving highlight region 110. Information relating to the media listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP). Other examples of time-independent content may include advertisements. Advertisements from an advertisement server may be broadcasted during regularly scheduled television programming or be accessed from the advertisement server based on user request.

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to media listings in grid 102 or may include options available from a main menu display. Features related to media listings may include searching for other air times or ways of receiving a media asset, recording a media asset, enabling series recording of a media asset, setting a media asset and/or channel as a favorite, purchasing a media asset, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast media asset listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

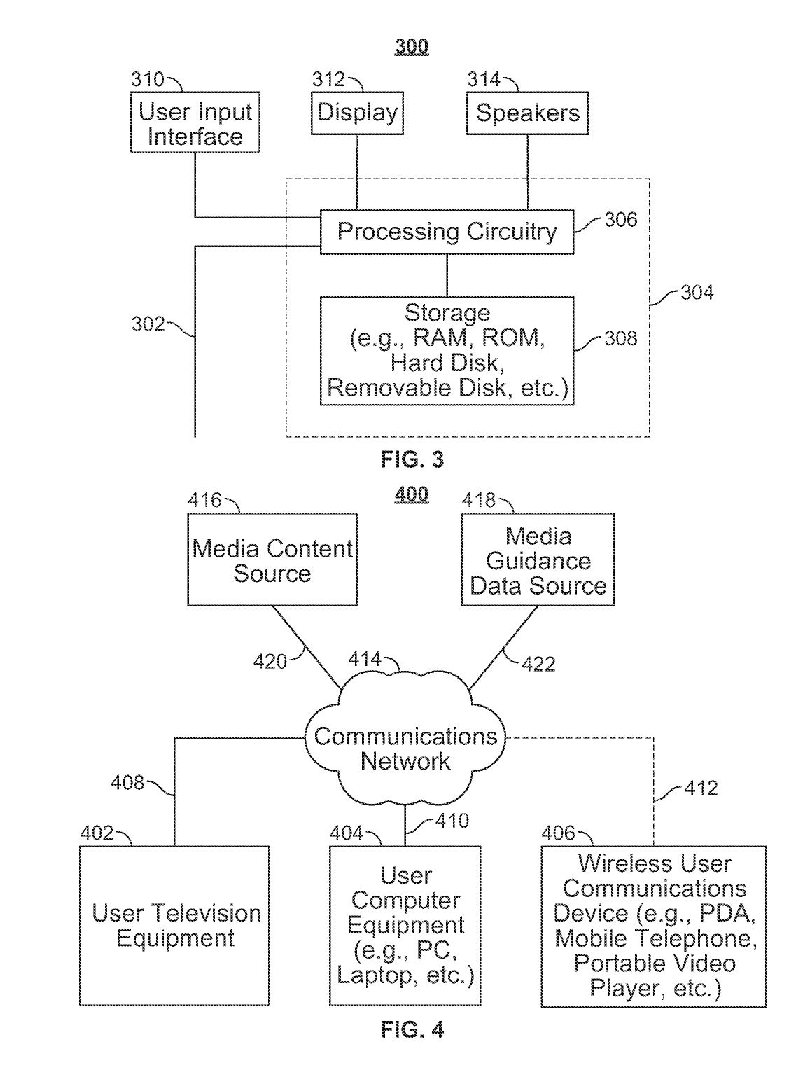

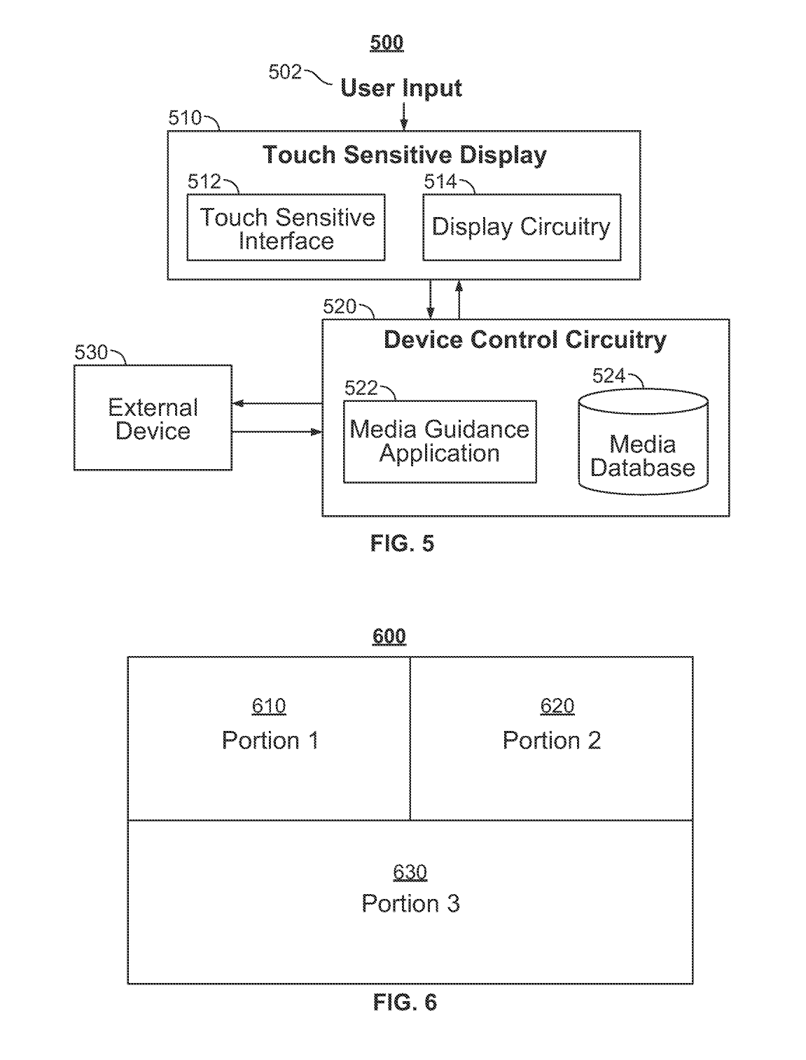

Users may access content and the media guidance application (and its display screens described above and below) from one or more of their user equipment devices. FIG. 3 shows a touch-sensitive device according to an illustrative embodiment of the invention. FIG. 3 shows a generalized embodiment of an illustrative user equipment device 300. More specific implementations of user equipment devices are discussed below in connection with FIG. 4 and FIG. 5. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, handheld devices, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

User equipment display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

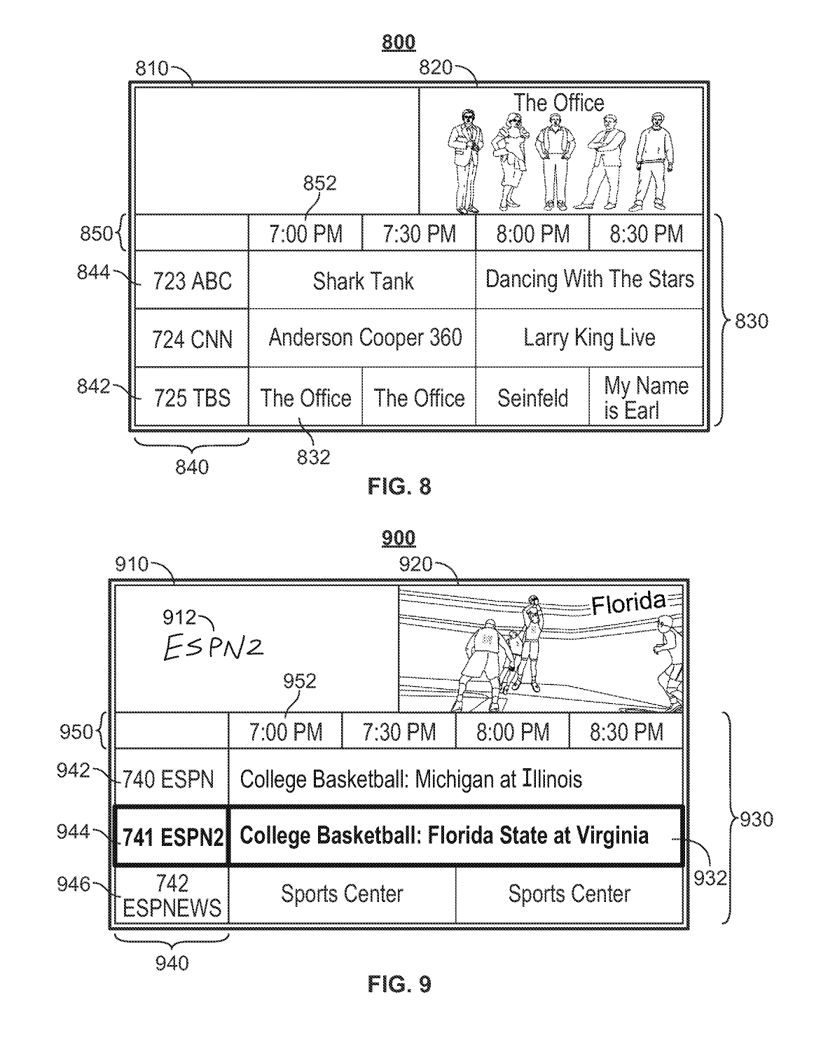

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from a remote database, Internet service, or using another suitable approach). In another embodiment, the media guidance application is a client-server based application. Data for use by a thick or thin client implemented on user equipment device 300 is retrieved on-demand by issuing requests to a server remote to the touch-sensitive device 300. In one example of a client-server based guidance application, control circuitry 304 runs a web browser that interprets web pages provided by a remote server. For example, in embodiments in which the media guidance application is a web site or other internet-based application, the display screens of FIGS. 1-2, 8-9, and 11-12 (discussed below), may be displayed to the user through a web browser implemented using control circuitry 304. As another example, the display screens of FIGS. 8-9, and 11-12 may be displayed on display 312. User indications and interaction with the display screens of FIGS. 8-9, and 11-12 may be received with user equipment display 312 and processed by circuitry 306.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a media asset.

User equipment device 300 of FIG. 3 can be implemented in system 400 of FIG. 4 as user television equipment 402, user computer equipment 404 (e.g., a tablet computer), wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a webcast provider, etc.) or may not be the originator of content (e.g., an on-demand content provider, an Internet provider of content of broadcast media assets for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television media guide that receives media guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

FIG. 5 shows a specific implementation of user equipment device 300 of FIG. 3 applied to a touch-sensitive display device. Touch-sensitive display 510 includes touch sensitive interface 512, which may be equivalent to display 312, and touch sensitive interface 512, which may be equivalent to user input interface 310 of user equipment device 300. Device control circuitry 520 may be equivalent to control circuitry 304. In addition to the features and functionalities described above, touch-sensitive display 510 and device control circuitry 520 may implement any of the technologies, and include any of the components, features, and functionalities described above in connection with FIG. 3. Control circuitry 520 includes processing circuitry for executing media guidance application 522. Control circuitry 520 may also include processing circuitry for communicating with (i.e., reading and writing from) media database 524. Database 524 may be one or more relational databases or any other suitable storage mechanisms. Although database 524 is shown as a single data store, one or more data stores may be used to implement a storage system.

A user may send instructions to control circuitry 520 using touch-sensitive display 510. Touch-sensitive display 510 may include various components that enable a screen to function both as an output display and as a touch-sensitive input interface. For example, touch-sensitive display 510 may include interface circuitry 512 and display circuitry 514. Although shown as two separate components, it should be understood that interface circuitry 512 and display circuitry 514 may be integrated into the same circuit or hardware component, and may be interconnected physically (e.g., layered) and/or electrically. User input interface 512 may include any suitable touch-sensitive interface elements, such as a grid of resistive and/or capacitive elements. Generally, user input interface 512 may implement a touch-sensitive screen using resistive, capacitive, acoustic, or optical technologies, or any other suitable touch-sensitive display technology or combination thereof. User input interface 512 may be capable of detecting a user's touch anywhere in the display area of the screen, and includes circuitry capable of outputting the location of the user's touch within the display area. In some embodiments, user input interface 512 implements multi-touch technology, and includes circuitry capable of outputting multiple locations corresponding to multiple contact points within the display area.

Database 524 may store media guidance data for a media guidance application received from a media guidance data source 418. Database 524 may store media-related information, including availability information (e.g., broadcast or streaming times), source information (e.g., broadcast channels, streaming address data, server/storage location), media titles, media descriptions, ratings information (e.g., parental control ratings, critic's ratings, etc.), genre or category information, actor information, logo data for broadcasters' or providers' logos, etc.), media format, on-demand information, or any other suitable media content information. The availability and source information included in database 524 may be used by the media guidance application to provide media content information (e.g., as shown in the display screens of FIGS. 1-2, 8-9, and 11-12) on display 510, or to provide any other suitable media guidance display.

With continuing reference to FIG. 5, database 524 may store advertising content for display in a media guidance application. Database 524 may store advertising content in various forms, including text, graphics, images, video clips, content of any other suitable type, or references to remotely stored content. Database 524 may also store links or identifiers to advertising content in other data stores. In some embodiments, database 524 may store indexes for advertising content in other local data stores, or may store identifiers to remote storage systems, such as URLs to advertisements provided by web servers. Database 524 may also store identifying information about each advertisement or advertisement element (e.g., associated advertiser, type of promotional, length of promotion, a television show, product, or service the advertisement is promoting, etc.), or may store indexes to locations in other local or remote storage systems where this information may be found.

Database 524 may also store media content or information related to media content accessible through a media guidance application. For example, control circuitry 520 may store and/or download the media content and/or media related information displayed in the display screens and overlays of FIGS. 8-9, and 11-12 to media database 524. Upon display to the user, control circuitry 520 may access media database 524 retrieve the requested information or media content.

With continuing reference to FIG. 5, device control circuitry 520 may access any of the information included in database 524. Control circuitry 520 may use this information to select, prepare, and display information on display 510. In particular, control circuitry 520 may use information obtained from database 524 to provide a media guidance application 522 to a user of the touch-sensitive device. For example, control circuitry 520 may use this information to display the display screens of FIGS. 1-2, 8-9, and 11-12. Control circuitry 520 may also update information in database 524 with data received from a media guidance data source 418 through communications link 302 of FIG. 3.

Touch-sensitive display 510 may have any of the features and functionalities of user equipment display 312. In particular, touch-sensitive display 510 may include both touch-sensitive interface components 512 and display circuitry 514. These elements may include any of the circuitry and may implement any of the technologies discussed above in connection with interface 310 and display 312 of FIG. 3. In addition, touch-sensitive interface components 512 and display circuitry 514 may be integrated into a single display. Accordingly, touch-sensitive display 510 is capable of detecting and processing user input 502. User input 502 may generally be a human touch in the form of a gesture, and may include one or more points of contact on the display screen. Gestures, as discussed above, may include tapping, slicking, sliding, or other suitable movements. It should be understood that an interface element, such as a stylus, may be used in place of direct human contact.

Multi-region touch-sensitive display 510 may be integrated with device control circuitry 520, or it may be a separate hardware device. In some embodiments, a multi-region touch-sensitive device may have its own touch screen and may additionally be connected to an external monitor, which itself may also be touch-sensitive. The multi-region touch-sensitive display 510 may communicate with device control circuitry through any suitable communications lines and using any suitable communications protocol. The multi-region touch-sensitive display 510 may include several portions configured to receive different types of user touch inputs. In some embodiments, these touch inputs may be handwritten inputs, navigation direction inputs, and selection inputs. In some embodiments, touch-sensitive display 510 may include its own display drivers, while in other embodiments, control circuitry 520 includes the display drivers for driving touch-sensitive display 510.

With continuing reference to FIG. 5, control circuitry 520 may communicate with an external device 530. External device 530 may be a server, user device, television equipment (e.g., a set-top box), a computer, a printer, a wireless router, another user equipment device 300 or any other suitable device. In one embodiment, a user interacts with touch-sensitive display 510 in order to provide instructions to control circuitry 520, which in turn configures external device 530. For example, a user may use the media guidance application 522 to control watch and record functions of a digital video recorder (DVR).

As discussed herein, an application running on user equipment with a touch-sensitive display may be used for navigating the media guidance application. A multi-region touch-sensitive device as shown in FIG. 6 allows the user to interact with such a media guidance application. The multi-region touch-sensitive device 600 is configured to receive user touch input to allow the user to interact with the media guidance application. The touch-sensitive screen of device 600 may be divided into several distinct portions. In the embodiment shown in FIG. 6, touch-sensitive screen of device 600 is divided into three distinct portions. These portions may overlap with one another or may be non-overlapping. Although this particular embodiment only shows three portions, touch-sensitive screen of device 600 may be divided into any number of portions.

In the embodiment shown in FIG. 6, portion 610 of the touch-sensitive screen may be configured to receive a first type of input from the user. When control circuitry 304 detects that portion 610 has been actuated, control circuitry 304 processes the user touch input as the first type of input and implements media guidance application functions associated with receiving a first type of input from the user in portion 610.

Similarly, in the embodiment shown in FIG. 6, portion 620 of the touch-sensitive screen is configured to receive a second type of input from the user. When control circuitry 304 detects that portion 620 has been actuated, control circuitry 304 processes the user touch input as the second type of input and implements media guidance application functions associated with receiving a second type of input from the user in portion 620.

Similarly, in the embodiment shown in FIG. 6, portion 630 of the touch-sensitive screen is configured to receive a third type of input from the user. When control circuitry 304 detects that portion 630 has been actuated, control circuitry 304 processes the user touch input as the third type of input and implements media guidance application functions associated with receiving a third type of input from the user in portion 630.

In some embodiments of the present invention, the first type of input received by portion 610 of the touch-sensitive device may be dedicated to receive user handwritten input. As referred to above and below, the word “dedicated” should be understood to mean configured to only perform the specific function. For example, control circuitry 304 processes input received in the first subregion of the touch-sensitive display as handwritten input regardless of what other subregions display or the other types of inputs that other subregions receive. As a result of determining that the user has actuated portion 610 of the touch-sensitive device 600, control circuitry 304 may execute handwriting recognition software to process the received handwritten input. The implemented handwriting recognition software processes the user touch input within portion 610 and converts the handwritten touch input into a character or a string of characters. There are several known methods for implementing handwriting recognition software and any of these methods may be used to process the handwritten touch input. Once the handwritten input is converted into a character string, control circuitry 304 may then use the character string to determine which media guidance application function to implement.

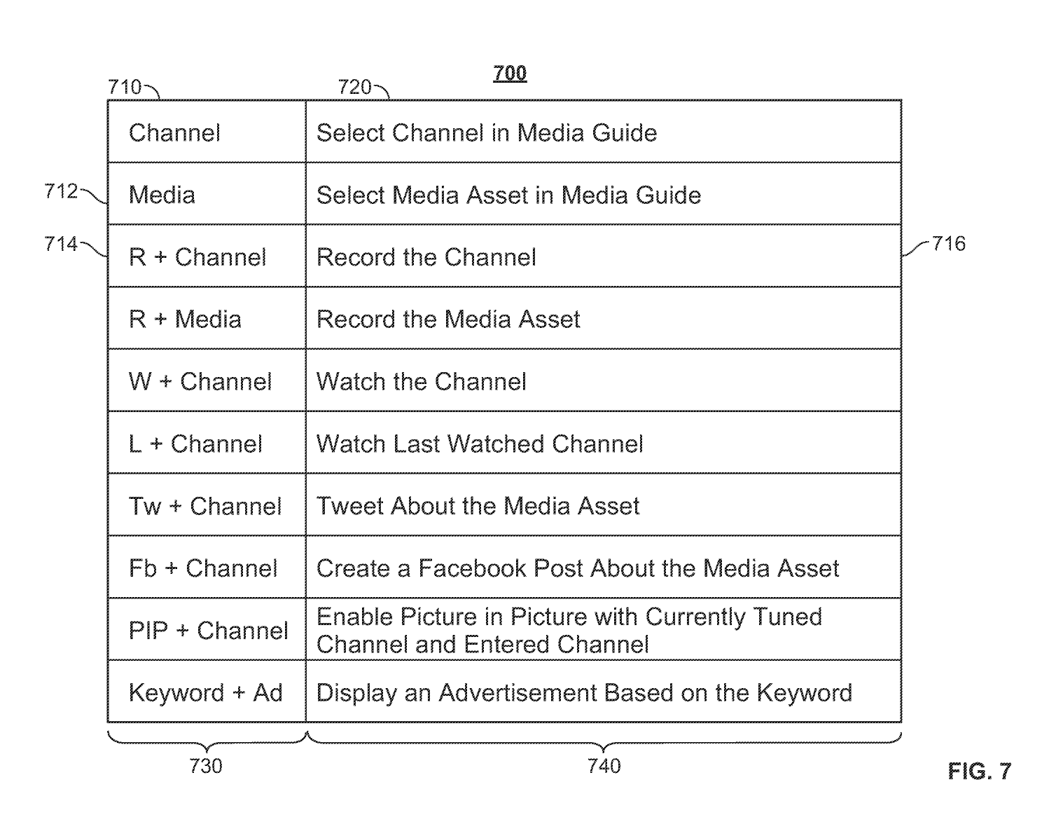

In an embodiment of the present invention, control circuitry 304 may use command table 700 as shown in FIG. 7 (discussed below) to determine which media guidance application function is associated with a given handwritten input. In particular, control circuitry 304 matches the character string of the processed handwritten input against a command table to identify the media guide application function the handwritten input indicates. Upon determining the command, the device may then proceed to implement the determined function.

The determined media guidance application function may be implemented on a different portion of the touch-sensitive screen than portion 610. For instance, control circuitry 304 may determine that the user handwritten input corresponds to displaying a media listing of a particular channel on the media guide. Once control circuitry 304 identifies that the user handwritten input desires to view the media listing for the given channel using command table 700, control circuitry 304 further determines that this media guidance application function of displaying a media listing of the particular channel is ascribed to portion 630 of the touch-sensitive device 600. Accordingly, control circuitry 304 implements the determined function by updating portion 630 of the touch sensitive device 600 to display the desired media listing.

In an embodiment, control circuitry 304 may determine that the handwritten input desires to select a media asset in the media guide specified by the handwritten input. Control circuitry 304 uses the character string of the processed handwritten input to search the interactive media guide for this particular media asset. Control circuitry 304 searches the title, description, and metadata associated with media listings in the interactive media guide for the character string.

The user handwritten input in portion 610 may contain any keyword or keywords associated with a media asset. For example, the user may search for words that belong to a title of a media asset. In another embodiment, the user may search for media assets by selecting the actors or characters in the media asset. In another embodiment, the user may search for media listings by writing the channel name or even the channel number of the media listing. The user may search media listings using other search terms as well. In another embodiment, the user may search for media listings by writing filter words associated with the program. Filter words may be the genre, actors, or any other parameter associated with the media assets the user desires to view. Control circuitry 304 may be configured to reduce the number of program listings in portion 630 of the touch sensitive device 600 based on these filter words.

In several embodiments of the present invention, the handwritten input may contain a task identifier in addition to the keyword identifying the media asset. Such a task identifier further specifies the particular media guidance application function that control circuitry 304 needs to execute with relation to the media asset or the channel of the media asset. In an embodiment, the task identifier may include instructions for control circuitry 304 to record a media asset or the channel of the media asset. In another embodiment, the task identifier may include instructions for control circuitry 304 to display the video of the channel in portion 620 of the touch sensitive screen. In another embodiment, the task identifier may include instructions for control circuitry 304 to display the channel previously displayed before the currently displayed channel in portion 620. In another embodiment, the task identifier may include instructions for control circuitry 304 to transmit a message to a social network to post a message related to the media asset. In another embodiment, the task identifier may instruct control circuitry 304 to update a social network status of the user (e.g., Twitter) related to the media asset. In another embodiment, the task identifier may include instructions for control circuitry 304 to enable picture-in-picture display of a desired channel with the currently displayed channel in portion 620 of the touch-sensitive device 600. In another embodiment, the task identifier may include instructions for control circuitry 304 to display an advertisement. For instance, the user might write “Ford Ad” on portion 610 of the touch sensitive screen and the task identifier word “Ad” may instruct control circuitry 304 to display advertisements related to the keyword “Ford.” In another embodiment, command table 700 may contain inputs for various filter words. When the user enters the filter word as the handwritten input on the touch sensitive screen of device 600, control circuitry 304 may process the entered handwritten input and determine that the command is to filter the media listings displayed in portion 630 of touch sensitive screen to display the media listings associated with the handwritten filter word.

In another embodiment, the task identifier may include instructions for control circuitry 304 to display a program on a particular monitor or viewing device. For example, the user may enter handwritten input of the form “Alcatraz on TV1” on the touch sensitive screen. In response to processing the entered handwritten input, control circuitry 304 may identify that the task identifier is TV1 and its corresponding media guidance application function in command table 700 is to display the specified program on the designated viewing device. Accordingly, control circuitry 304 may implement this command by displaying the identified program, Alcatraz, on the television designated TV1. The user may have previously designated the multiple viewing devices within range of the touch sensitive device 600 with keywords such as TV1. Alternatively, control circuitry 304 may automatically assign viewing devices default identifiers such as TV1 upon detecting their presence. These viewing devices may belong to the same network as touch sensitive device 600. In another implementation, the user may enter handwritten input of the form “Dora on bedroom TV.” In response to receiving this handwritten input, control circuitry 304 may process the handwritten input and determine that the program “Dora” should be displayed on the viewing device designated as the “bedroom TV” by querying command table 700. In response to determining this media guidance application function, control circuitry 304 may tune the viewing device designated as the “bedroom TV” to the specified “Dora” program.

In another embodiment, control circuitry 304 may be configured to recognize handwritten input commands entered on any portion of the touch sensitive screen of device 600. For example, if control circuitry 304 detects that the user has handwritten the phrase “Ford Ad” on any portion of touch-sensitive device 600, control circuitry 304 may be able to detect the input as handwritten input and accordingly process the handwritten input into a character string. Control circuitry 304 may accordingly use this character string to determine the media guidance application function to be implemented using command table 700.

In an embodiment, control circuitry 304 converts the user handwritten input to a character string at the same time as when the user is writing in portion 610 of touch-sensitive device 600. In another embodiment, control circuitry 304 initiates searching the interactive media guide listings based on the handwritten touch input only after control circuitry determines that the user has completed writing in portion 610. Control circuitry 304 may determine that the user has completed entering the handwritten input once a confirmation button such as OK or DONE has been selected in region 610 of the touch-sensitive device 600. In another embodiment, control circuitry 304 may determine that the user has completed entering the handwritten input once a predetermined amount of time has lapsed since portion 610 was last actuated.

To make the handwritten input search more user friendly, control circuitry 304 may display suggestions to the user as the user is entering the handwritten input. The suggestions may be based on media guide data received from media guidance data source 418. Such suggestions may allow the user to correct spelling mistakes. Such suggestions may also aid the user when certain portions of the handwritten input are indecipherable. In such a situation, control circuitry 304 is able to provide suggestions based on the decipherable portions of the handwritten input. When control circuitry 304 determines that it cannot convert the handwritten input into a character, control circuitry 304 displays a notification prompting the user to reenter the search term.

In some embodiments, the handwritten input entered on portion 610 of the touch sensitive screen may be related to advertisements. Control circuitry 304 may determine by processing the handwritten input that one of the task identifiers contained in the handwritten input relates to watching an advertisement. Command table 700 may accordingly contain instructions for displaying an advertisement related to the keywords entered in addition to the advertisement task identifier in the entered handwritten input. In response to determining that the command is to watch an advertisement, control circuitry 304 may tune to an advertisement on portion 620 of the touch sensitive display. In another implementation, control circuitry 304 may display the advertisement on a second screen such as a television screen instead of displaying it in a portion 620 of the touch sensitive display.

In some embodiments, control circuitry 304 may recognize that the handwritten input corresponds to an advertisement currently displayed on portion 620 of the touch sensitive screen or on a secondary screen such as user television equipment 402 for the currently displayed media asset. In response to determining that the handwritten input corresponds to a currently displayed advertisement, control circuitry 304 may display an option to view additional or extended advertisements related to the handwritten input or the currently displayed advertisement on touch sensitive device 600 or on user television equipment 402. These extended advertisements and additional advertisements may be received on the user equipment from an advertisement server which may be part of media content source 416 or a separate advertisement server (not shown).

In some embodiments, control circuitry 304 may determine which advertisement to display in response to the user's handwritten input based on user specific data. For instance, if the user handwritten input in portion 610 of the touch sensitive screen returns multiple results for additional or extended advertisements, then control circuitry 304 may determine which advertisement to display based on user specific data. In one implementation, the advertisement viewing history of the user may be taken into consideration by control circuitry 304. In another implementation, user specific data may include past purchases made by the user. User specific data may be any user preference data collected by the media guidance application running on the touch sensitive device 600. Control circuitry 304 may determine which of the several advertisement results to display in response to the handwritten input on portion 610 based on such user specific data. Using media application guidance's user collected data may allow the advertiser of a specific brand to serve up the most appropriate advertisement to the user in response to handwritten input in portion 610 of the touch sensitive screen based on the understanding of the user. For example, if the Coca Cola Company has purchased advertising access to the user, control circuitry 304 could determine whether to display an advertisement related to Coke or an advertisement related to Coke Light on user equipment devices 402, 404 and 406. Control circuitry 304 may display the Coke Light advertisement as a result of analyzing past purchases and past viewing history of the user on user equipment devices 402, 404 and 406.

In some embodiments, control circuitry 304 may be configured to recognize graphics drawn by the user as part of the handwritten input. These graphics may include certain shapes or patterns that may be associated with particular media guidance application functions in command table 700. In an implementation, control circuitry 304 may be configured to recognize the position of the graphic with respect to the words entered in the handwritten input on the touch sensitive screen of device 600. In response to determining the position of the graphic with respect to the words in the handwritten input, control circuitry 304 may be configured to determine the exact media guidance application function associated with the handwritten input. For example, the user may write “Bears Game” and drawn a rectangle around the words inputted in the handwritten input. Upon detecting the input as handwritten input, control circuitry 304 may query command table 700 for the media guidance application function associated with the rectangle placed around the handwritten words. Upon determining that the rectangle drawn around the words in the handwritten input translates into tuning to the media asset specified by the handwritten input on the primary viewing device, control circuitry 304 displays the media asset specified by the handwritten input on the primary viewing device. This type of graphic and its associated media guidance application function is only one of several types of graphics entered that handwritten input may be associated with.

In some embodiments of the present invention, portion 630 of the touch-sensitive device may be dedicated to display an interactive media guide. Various media guide listings arranged by channel number and broadcast time may be displayed in portion 630. Portion 630 of the touch-sensitive device 600 may be dedicated to receive a second type of input. In one embodiment, the second type of input is a navigation input to browse the interactive media guide. In another embodiment, the second type of input is a selection input to select various media guide listings. When control circuitry 304 determines that portion 630 of the touch-sensitive device 600 has been actuated, control circuitry 304 may accordingly determine that portion 630 is dedicated to receive a second type of user input. Subsequently, control circuitry 304 may process the user touch input received in portion 630 as the second type of input.

In some embodiments, the second type of user input is a navigation or a selection input. If control circuitry 304 determines that the touch input is a navigation input, control circuitry 304 may further determine the direction of the navigation input and may accordingly scroll the media guide in that direction.

In one embodiment, the navigation touch input is a swipe or a flick of the finger or stylus in a given direction. The user may wish to browse the interactive media guide by scrolling up, down, right or left. In such an embodiment, control circuitry 304 would determine the direction of the navigation input.

If control circuitry 304 determines that the direction of the navigation input in portion 630 is right, control circuitry 304 may display media listings for earlier broadcast times. Accordingly, as a result of determining that the direction of the navigation input in portion 630 is right, control circuitry 304 may update a row of time identifiers such that the time identifiers correspond to earlier times than the time identifiers displayed before scrolling right. Control circuitry 304 may accordingly display the media listings that correspond to these earlier time identifiers. If control circuitry 304 determines that the direction of the navigation input in portion 630 is left, control circuitry 304 may display media listings for later broadcast times. Accordingly, as a result of scrolling left, control circuitry 304 may update the row of time identifiers such that the time identifiers correspond to later times than the time identifiers displayed before scrolling left and may accordingly display the media listings that correspond to these later time identifiers. If control circuitry 304 determines that the direction of the navigation input in portion 630 is down, control circuitry 304 may display media listings for additional content providers. In one embodiment, these different content providers displayed as a result of user touch input to scroll downwards may have channel identifiers with lower channel number values from the channel numbers displayed immediately before control circuitry 304 receives the user touch input to scroll down. Accordingly, as a result of scrolling down, control circuitry 304 may update a column of channel identifiers such that the channel identifiers correspond to numerically lower channel number values than the channel identifiers displayed before scrolling downward and may accordingly display the media listings that correspond to these new channel identifiers. If control circuitry 304 determines that the user touch input in portion 630 corresponds to scrolling up, the interactive media guide displays media guide listings for different content providers. In one embodiment, these different content providers displayed as a result of user touch input to scroll upward may have channel identifiers with higher channel number values from the channel numbers displayed immediately before control circuitry 304 received the user touch input to scroll up. Accordingly, as a result of scrolling up, control circuitry 304 may update the column of channel identifiers such that the channel identifiers correspond to numerically higher channel number values than the channel identifiers displayed before scrolling upwards and accordingly may display the media listings that correspond to these new channel identifiers.

Control circuitry 304 may also be configured to cycle through the row of channels as a result of receiving user touch input to scroll up or scroll down. For example, once control circuitry 304 detects that the last row of the interactive media guide is being displayed and touch input is received to scroll up, control circuitry 304 may display the media guide listings starting from the first row of the interactive media guide. Similarly, once control circuitry 304 detects that the first row of the interactive media guide is being displayed and touch input is received to scroll down, control circuitry 304 may display the media guide listings starting from the last row of the interactive media guide.

If control circuitry 304 determines that the second type of user input received in portion 630 of touch-sensitive device 600 is a selection input, then control circuitry 304 may further determine which region of the interactive media guide display in portion 630 the user's input corresponds to. After control circuitry 304 determines which region of portion 630 the user has touched, control circuitry 304 may select that region of the media guide.

In certain embodiments, control circuitry 304 may select a media listing in portion 630 by tapping the screen twice. Highlighting a media listing may display additional information related to the media listing in portion 630 of the touch-sensitive device 600. Control circuitry 304 may further determine whether the media asset of the selected media listing is currently being broadcast, scheduled to be broadcast in the future, has already been broadcast, or is a non-linear program. If control circuitry 304 determines that the selected media asset is currently being broadcast, control circuitry 304 may tune to the selected media asset and display the media asset in portion 620. In another embodiment, control circuitry 304 may record the media asset of the selected media listing. In yet another embodiment, control circuitry 304 may simultaneously display the media asset in portion 620 and record the selected media asset.

If control circuitry 304 determines that the media asset of the selected media listing is going to broadcast in the future, then control circuitry 304 may present the user with the option to tune to the media asset at the scheduled future time, create a reminder to watch the media asset at a predetermined time before the media asset's scheduled broadcast time or schedule the media asset to be recorded.

If control circuitry 304 determines that the media asset of the selected media listing has already been broadcast in the past, then control circuitry 304 may allow the media asset to be displayed if it was previously recorded and is still available in storage 308.

If control circuitry 304 determines that the media asset of the selected media listing is a VOD program, then control circuitry 304 may present the user with the option to order the media asset. If the selected media asset requires payment, control circuitry may provide the user with an option to enter his payment information. The user's payment information may be transmitted to a headend sever. After the user's payment has been processed at the headend, the VOD program may then be received from the media content source 416.

In an embodiment of the present invention, control circuitry 304 may search the media guide based on keywords identifying a media asset in the handwritten input to determine if any media listings were found that correspond to the entered search terms. There might be only one corresponding media listing found, several corresponding media listings found, or no corresponding media listings found.

If control circuitry 304 determines that there is only one media guide listing that results from searching the interactive media guide based on the handwritten user input, control circuitry 304 may display the media listing associated with the search result in portion 630 of the touch-sensitive display. In an embodiment, control circuitry 304 may display a portion of the interactive media guide in portion 630 that contains the media guide listing associated with the search result. The displayed portion of the media guide in portion 630 may be the corresponding area of the media guide where the media guide listing associated with the search result is originally located. For instance, the corresponding area of the media guide displayed may be at a different time or channel than the previously displayed time and channel. Accordingly, control circuitry 304 may update the time identifiers and channel identifiers displayed along with the media guide listings to those corresponding to the media guide listings associated with the search result.

If control circuitry 304 determines that there are multiple corresponding media listings that match the user handwritten input, control circuitry 304 may display a notification on portion 630 of the touch-sensitive screen that multiple results were found. Control circuitry 304 may then display a list of the search results and allow the user to select one of the search results. Upon selection of one of the media listings from the search result, control circuitry 304 may then proceed to update portion 630 with the selected search result in keeping with the embodiments described above. In another embodiment, if control circuitry 304 determines that there are multiple corresponding media listings that match the user handwritten input and that all of these media listings are associated with the same time identifier, then control circuitry 304 may display the rows for those resulting media listings in portion 630.

If control circuitry 304 determines that there are no corresponding media guide listings that match the user handwritten input, then control circuitry 304 may display a notification on portion 630 that no corresponding media asset was found. In another embodiment, in response to determining that there are no corresponding media guide listings that match the user handwritten input, control circuitry 304 may display suggestions of media listings that do not match the handwritten input.

Control circuitry 304 may also display a history of previously searched user handwritten input. Portion 630 of touch-sensitive device may contain a button or region that when actuated by the user, may allow control circuitry 304 to display a list of previously searches. Control circuitry 304 may be further configured to allow the user to select one of the previously searched character strings from the list of previous searches. Upon receiving user selection of a previously searched character string, control circuitry 304 may search the interactive media guide and update portion 630 as discussed in the embodiments above. The user may also be provided an option to clear the list of previous searches.

In some embodiments of the present invention, portion 620 of the touch-sensitive device 600 may be dedicated to display a video of a media asset. Portion 620 may be further configured to display video of multiple media assets in picture-in-picture mode. Furthermore, portion 620 may be dedicated receive a third type of user input.

When control circuitry 304 determines that actuation was received in portion 620 of touch-sensitive device 600, control circuitry 304 may process the touch input as a third type of user input.

In one embodiment, the third type of user input may be one that controls playback of the media asset displayed in portion 620. Control circuitry 304 may also allow the user to control the audio of the displayed media asset in portion 620. In this embodiment, the third type of user input may allow the user to actuate a volume bar in portion 620 to increase or decrease the audio volume of the displayed media asset in portion 620.

In another embodiment, control circuitry 304 may receive a third type of input to allow the user to view the video displayed in portion 620 in full-screen mode. When the user actuates a full-screen button in portion 620, the video stretches to cover the touch-sensitive screen including portions 610, 620 and 630. Accordingly, the third type of input here is the user's actuation of a full-screen button. In response to receiving such a third type of input, control circuitry 304 enables the display of the media asset in full-screen mode.

In an embodiment of the present invention, there may be several buttons displayed in portion 630 of the touch sensitive device 600 to control video playback, control audio and to enable full-screen display of the video. When control circuitry 304 determines that portion 620 of the touch-sensitive device 600 has been actuated, control circuitry 304 may further determine which one of these playback control buttons the user has pressed in portion 620. When control circuitry 304 determines which button in portion 620 has been pressed, control circuitry 304 further determines the function associated with that button and subsequently implements that function.

In an embodiment, the video and audio control buttons and the full-screen display button may be hidden from display. Once the user taps portion 620 once, these buttons may be superimposed on top of the displayed video. After control circuitry 304 determines that a predetermined amount of time has passed without any user actuation of these buttons in portion 620, these buttons may be hidden from display. In another embodiment, the video and audio control buttons and the full-screen display button may always be displayed superimposed on top of the displayed video.

In another embodiment, control circuitry 304 may allow the user to control playback of the media asset in portion 620 by receiving different types of touch input gestures. For instance, control circuitry 304 may be able to process a double tap in portion 630 as a play/pause command. If control circuitry 304 determines that portion 620 receives a double tap while a media asset in portion 620 playing at the time the double tap user touch input is received, control circuitry may pause playback of the media asset in portion 620. On the other hand, if control circuitry 304 determines that the media asset in portion 620 is not playing at the time portion 620 receives the double tap user touch input, control circuitry 304 may play the media asset in portion 620. There may be several other gestures used to indicate the play/pause command besides double tapping portion 620.

In other embodiments, control circuitry 304 may also be configured to recognize unique touch inputs entered in portion 620 that are associated with other playback control functions such as stopping playback, fast-forwarding or rewinding the video of the media asset, enabling full-screen mode and increasing or lowering the volume of the audio track associated with the media asset displayed in portion 620.

FIG. 7 shows an illustrative command table that associates different types of handwritten input commands with corresponding media guidance functions in accordance with various embodiments of the invention. Individual entries in column 730 of such a command table may contain the handwritten input command and entries in column 740 may contain the media guidance application function associated with those handwritten input commands.

Once the handwritten input in portion 610 is processed by control circuitry 304 into a character string, control circuitry 304 queries command table 1000 to determine which media guidance application function corresponds to the entered handwritten input. After control circuitry 304 determines the appropriate function from the command table, control circuitry 304 may proceed to implement the determined function.

The command table may be stored in storage 308 and accessed using processing circuitry 306. When the user enters a handwritten command on user input interface 310, control circuitry 304 processes the handwritten input to convert it into a character string. In one embodiment, the character string may be stored in storage 308. Processing circuitry 306 queries the command table stored in storage 308 with the character string stored in storage 308. After querying the command table, processing circuitry 306 may then determine the identified media guidance application function and execute it.

If control circuitry 304 cannot find the associated function corresponding to a processed handwritten input, control circuitry 304 may display a notification on touch-sensitive device 600 that the entered command is an invalid command.

In the embodiment shown in FIG. 7, command table 700 contains several entries. This table is not a complete list of the different types of valid handwritten input commands and their corresponding media guide application functions. Any number of additional functions and valid types of handwritten input commands may be stored in command table 700.

In an embodiment, command table 700 may be configured to accept additional user-customizable valid handwritten input commands. For example, the user may desire to add additional forms of commands that touch-sensitive device 600 may consider as a valid handwritten input command. Control circuitry 304 may allow the user to add handwritten input commands along with their associated user-specified media guidance application function to command table 700.

Control circuitry 304 may be configured to either receive handwritten input commands in the form of simply a channel keyword as shown in entry 710, media asset keyword as shown in entry 712, or a combination of task identifiers and channel and media asset keyword. Channel keyword may contain the channel number of the channel name of the desired channel. Media asset keyword might contain the name, genre, or any other information associated with the media asset. Column 730 shows several examples of entries that include a combination of task identifiers and such media asset or channel keywords. One such entry 714 contains a task identifier R and the channel number. The corresponding media application function 716 dictates that such a handwritten input command indicates a user command to record the channel.

In some embodiments, the media guidance application may be configured to display a media guide schedule. The display may include three regions configured to receive different types of inputs. For example, the first type of input may be a handwritten input. The second type of input may be a navigation input or a selection input. The third type of input may be an input to control playback of a video.

FIG. 8 displays an illustrative touch-sensitive screen 800 running a media guidance application as discussed in the embodiments above. Portions 810, 820, and 830 correspond to portion 610, 620, and 630, respectively, of the touch-sensitive device 600 of FIG. 6. Portions 820 and 830 correspond to portions 122 and 102 of the media guidance application shown in FIG. 1. The interactive media guide listings displayed in such a media guide may be organized by time of broadcast and content provider, similar to grid 102 of FIG. 1. For example, media listing 832 “The Office” is arranged in a grid that corresponds to channel identifier 842 and time identifier 852. The media asset for media listing 832 which airs on TBS at 7:00 PM corresponds to row allocated for channel identifier 842, the row for media assets broadcast on the TBS channel and to the column allocated to time identifier 852, the column for media assets broadcast at 7:00 PM. Certain media assets such as media asset 834, “Anderson Cooper 360,” might belong to multiple columns since they might air for a period longer than the minimum time period allocated for a time identifier.

In the embodiment shown in FIG. 8, the media assets are arranged according to a predetermined order. Row 850 of time identifiers is arranged in order of increasing broadcast time. Similarly, column 840 of channel identifiers is arranged in order of increasing channel numbers.

In the embodiment shown in FIG. 8, the content providers displayed are associated with broadcast channels. Content providers may be non-broadcast channels that contain non-linear programming such as pay-per-view and other VOD channels. Content providers may also include text only channels, recorded content channels, and Internet content channels.

While broadcast media listings are always assigned a broadcast time and a channel number, non-linear media may not always be associated with a broadcast time or a channel number. For instance, certain VOD program listings such as media listing 114 for “HBO On Demand” may only contain a channel identifier (channel number 5 for HBO), the listing may not be associated with a time identifier. Selecting such a VOD listing may allow the user to select one of several VOD programs available from media content source 416. VOD program listings may not be assigned a single time identifier. Instead, they may span the entire row associated with their corresponding channel identifier. In certain other instances, media listing such as Internet content listing 118 may not be assigned a predetermined channel. In one embodiment, control circuitry may assign such media listings a channel number such that all the Internet content listings are assigned channel numbers within a predetermined range of channel numbers (i.e., channels 400-499 may be reserved for Internet content listings). In another embodiment, control circuitry 304 may not assign such non-linear media listings channel numbers. Instead, control circuitry 304 may assign such media listings rows in the interactive media guide such that their channel identifier does not contain a channel number but only a description of the type of non-linear content displayed. Similar techniques may be applied to other non-linear media listings such as recorded content listings like recorded content listing 116.

Portion 810 of FIG. 8 is configured to receive a first type of input. In particular, this first type of input may be user handwritten input. When a user enters handwritten input into portion 810 of a media guide such as FIG. 8, control circuitry 304 determines that portion 610 touch-sensitive screen of a device 600 that is running the media guidance application is configured to receive that handwritten input. In fact, FIG. 9 shows the illustrative media guidance application as displayed in FIG. 8 after it receives the user handwritten input 912 in region 910. Portions 910, 920, 930, 940, and 950 correspond to portion 810, 820, 840 and 850, respectively, of the touch-sensitive screen 800 of FIG. 8.

Once control circuitry 304 determines that the user has written handwritten input 912 (i.e, “ESPN2”) in portion 910, control circuitry 304 processes the handwritten input 912 into a character string. Control circuitry 304 then identifies the media guidance application function specified by the handwritten input by querying command table 700 with the character string of the converted handwritten input 912. In particular, the handwritten input of ESPN2 corresponds to a channel entry according to entry 710 in command table 700. Control circuitry 304 implements the corresponding function 720 to select the ESPN2 channel in the media guide display of portion 930.

Accordingly, control circuitry 304 searches the interactive media guide listings and updates the display of portion 930. After the control circuitry determines that the user handwritten entry 912 corresponds to only one channel name, control circuitry 304 displays the relevant portion of the interactive media guide that contains the media listing for the channel “ESPN2.” Accordingly, control circuitry 304 updates the column of channel identifiers 840 as shown in FIG. 8 with a new row of channel identifiers 940. The new column of channel identifiers includes channel identifier 944, the channel identifier corresponding to the ESPN2 channel (Channel 741).

In the embodiment pictured in FIG. 9, column 940 of channels is arranged in a manner such that the media listing associated with the ESPN2 search result is placed in the center of portion 930. Channel identifier 942 and 946, corresponding to channel 740 and channel 742, respectively, are displayed in portion 930. Since the ESPN2 handwritten touch input was determined by control circuitry 304 to correspond to a channel number, control circuitry 304 does not change the display of time identifiers 950. When the user handwritten input corresponds to a particular media listing that only broadcasts at a particular time, control circuitry 304 is configured to change row 950 of time identifiers to display the corresponding time identifier for the resulting media listing and the time identifiers adjacent to the time identifier for the resulting media listing.

In another embodiment, control circuitry 304 clears the previous display of portion 930 and displays only the media listing associated with the search result. For example, once control circuitry 304 finds the media listing that corresponds to the user handwritten input 912 only media listing 932 and its channel identifier 944 are displayed.

In another embodiment, control circuitry 304 adds the media listing associated with the search result to a list of previously displayed media listings in portion 930. For example, after control circuitry determines that the user handwritten input corresponds to the ESPN2 channel, control circuitry 304 may add the entire row for the ESPN2 channel to the display of the media listings displayed in portion 630 before the user handwritten input 912 was entered in region 610.

In another embodiment, control circuitry 304 may be configured to reduce the number of media listings displayed in portion 930 of touch sensitive screen 900 based on filter words entered in handwritten input 912. For example, the user may enter handwritten input “Sports” on the touch sensitive screen 900. After control circuitry 304 processes the handwritten input 912, control circuitry 304 identifies the media listings associated with the filter word “Sports” and accordingly control circuitry 304 displays all the media guide listings associated with sports.

In the embodiment pictured in FIG. 9, the user enters a second type of input on portion 930, especially on media asset 932 for “College Basketball: Florida State at Virginia.” Once control circuitry 304 determines that another portion of the touch-sensitive device 600 has been actuated, control circuitry 304 further determines that the actuated portion is configured to receive a second type of user input. Control circuitry then determines whether the second input is a navigation input or a selection input and it determines that the user has selected media asset 932. According to an embodiment, control circuitry 304 further determines that media asset 932 is a currently broadcast program and displays a video of media asset 932 on portion 920 of FIG. 9.

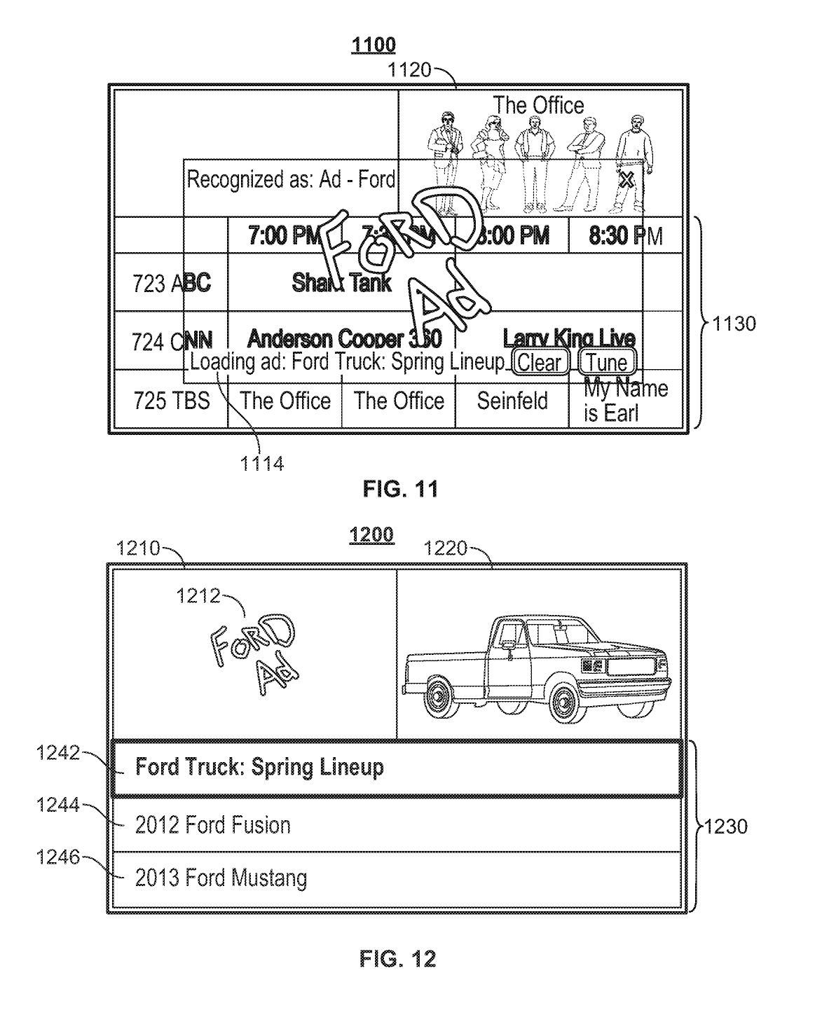

FIG. 11 shows an illustrative display of the touch-sensitive screen of FIG. 8 in which handwritten input for an advertisement is entered on a portion of a touch-sensitive screen. Portions 1120 and 1130 correspond to portions 820 and 830, respectively, of the touch-sensitive screen 800 of FIG. 8. The user enters handwritten input 1112 in portion 1110 of the touch sensitive screen 1100. Portion 1110 of touch sensitive screen may correspond to portion 810 of the touch sensitive screen 800 dedicated to receiving handwritten input. Portion 1110 may also correspond to any other portion of touch sensitive screen 800. As FIG. 11 illustrates, handwritten input for an advertisement may be entered in a portion separate from the portion corresponding to portion 810 of FIG. 8.

When control circuitry 304 detects that handwritten input 1112 has been entered on touch sensitive screen 1100, control circuitry 304 processes input 1112 as a handwritten input. Control circuitry 304 may determine that the word “Ad” in the handwritten input 1112 is a task identifier that is associated with the program guidance application function of displaying an advertisement in a separate portion of the touch-sensitive device 1100 or a secondary viewing device such as the user television equipment 402. In response to determining such a media guidance application function associated with the processed handwritten input, control circuitry 304 may search an advertisement database for the keyword in the handwritten input 1112. Control circuitry 304 may determine that the word “Ford” in input 1112 corresponds to the handwritten input keyword and searches the advertisement database for advertisements related to Ford.

In some embodiments, control circuitry 304 determines that an advertisement related to handwritten input 1112 is being displayed on the touch sensitive screen 1100 or on a secondary viewing device such as user television equipment 402. In response to determining that an advertisement related to handwritten input 1112 is being currently displayed, control circuitry 304 displays an option on touch sensitive screen 1100 to display an extended version of the displayed advertisement or to display an additional advertisement related to the handwritten input 1112. For example, when control circuitry 304 detects that handwritten input 1112 for a Ford advertisement is being requested, control circuitry 304 displays an option 1114 on touch sensitive screen 1100 to display an extended advertisement called “Ford Truck: Spring Lineup” that is related to the handwritten input 1112.

In another embodiment, control circuitry 304 may configured to display the advertisement on a viewing device specified by the user in the handwritten input. For example, the user may enter “Ford Ad on bedroom TV.” Control circuitry 304 may process the handwritten input and query command table 700 to determine that the handwritten input includes the task identifier for which viewing device to display the advertisement on. Accordingly, control circuitry 304 may display the corresponding advertisement related to “Ford Ad” as described above on the viewing device designated as “bedroom TV.”

Advertisers may be charged a premium fee based on the number of extended advertisements viewed by users. In some embodiments, control circuitry 304 may be configured to send an indication to a headend server 416 that a user has viewed extended programming. For instance, when a user views the “Ford Truck: Spring Lineup” video, control circuitry 304 may send a message to the headed server 416 that the extended advertisement video for “Ford Truck: Spring Lineup” has been viewed an additional time. Accordingly, the advertiser for this extended advertisement may be charged per view of the extended advertisement. In another embodiment, control circuitry 304 may determine the duration of time a user views the extended advertisement. For example, if control circuitry 304 detects that the “Ford Truck: Spring Lineup” video was only displayed for one minute out at the user touch screen device or at a user television equipment instead of the full ten minutes of the extended advertisement, control circuitry 304 may transmit to headend server 416 that the extended advertisement was only watched for one minute. The advertiser may be charged a variable fee based on the duration of time that their extended advertisements have been viewed by the user. In yet another embodiment, long term advertisement access to user equipment devices 402, 404 and 406 may be sold to an advertiser for a duration of time. For example, an advertiser may be charged to provide advertisements to user equipment devices 402, 404, and 406 for an entire evening or a week by paying a fixed fee. In some implementations, control circuitry may be more likely to display advertisements for advertisers who have paid for such long term access on user equipment devices 402, 404, and 406.

In some embodiments, the word “Ford” returns several advertisement results. If control circuitry 304 detects that multiple advertisement results are found, then control circuitry 304 may be configured to display the advertisement that best matches the user's interest in another portion of the touch sensitive screen 1100 than portion 1100. Control circuitry 304 may determine the user's interest by using data collected by the media guidance application on the user's past viewing history or his past purchases. Targeting the advertisement to the user's preferences might enable the advertisement provider to reach targeted audiences that are likely to well receive their advertisement content. In another embodiment, the handwritten input only corresponds to a single advertisement. Control circuitry 304 displays this resulting advertisement on another portion of the touch sensitive screen 1100 than portion 1100.

FIG. 12 shows the illustrative media guidance application running on the touch sensitive device as displayed in FIG. 11 after it receives the user handwritten input 1112 in region 1110. Portions 1220 and 1230 correspond to portion 1120 and 1130 of FIG. 11. Handwritten input 1212 corresponds to handwritten input 1112 of FIG. 11. Portion 1210 corresponds to portion 610 of FIG. 6.

After control circuitry 304 processes handwritten input 1112 of FIG. 11, control circuitry 304 searches an advertisement database for Ford advertisements. In the embodiment shown in FIG. 12, control circuitry 304 determines that there are several Ford advertisements for the user to select from. Control circuitry 304 presents the user with the option to select the multiple advertisement search results corresponding to the handwritten input 1112 in FIG. 11. Control circuitry 304 may display advertisement search results 1242, 1244, and 1246 in portion 1230. Control circuitry may also display the entered handwritten input 1212 that generated the advertisement search results 1242, 1244, and 1246 in portion 1210. The user may select one advertisement search result by touching or tapping the portion of the touch sensitive screen that displays the advertisement search result. As control circuitry 304 detects that the user has selected a particular search result, control circuitry 304 displays the selected advertisement in portion 1220. For example, FIG. 12 shows that the user has selected the “Ford Truck: Spring Lineup” advertisement search result. Accordingly, control circuitry 304 displays the advertisement corresponding to search result 1242 in portion 1220. In some embodiments, the advertisement search results displayed may be search results based on a combination of the handwritten input 1212 and the user's preferences as determined by control circuitry 304.

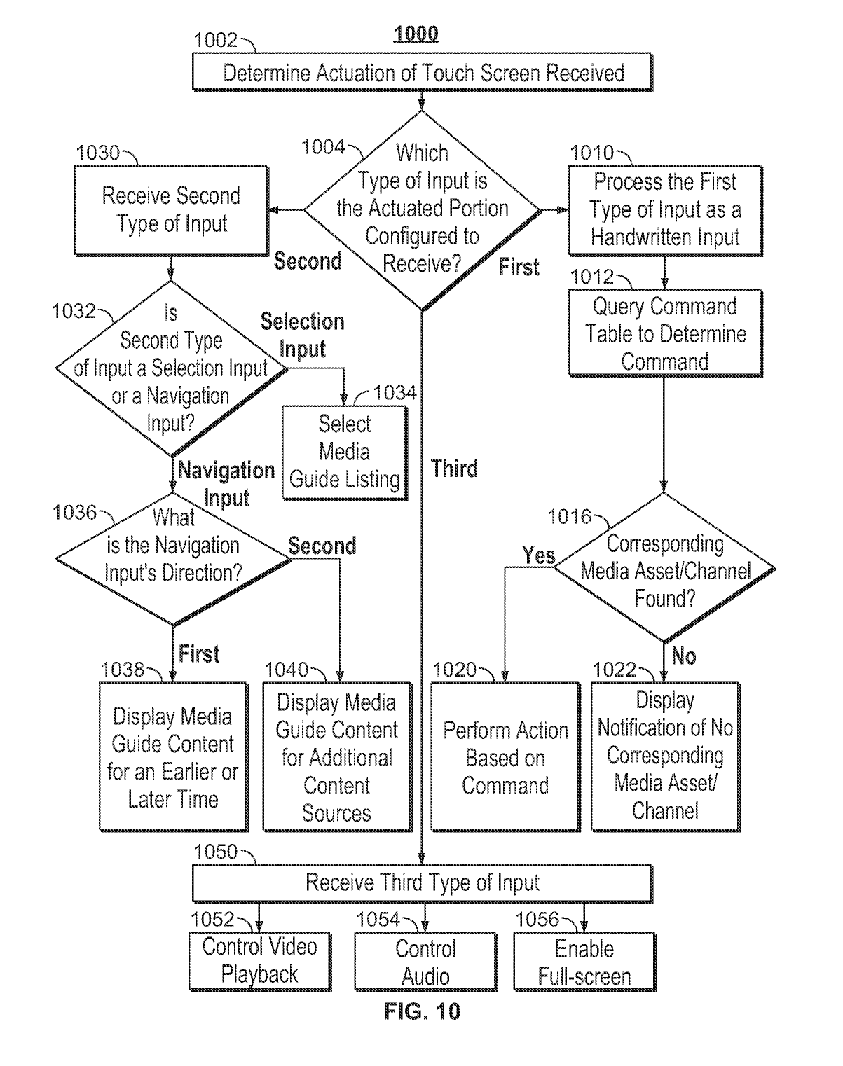

The following flow chart of FIG. 10 serves to illustrate processes involved in some embodiments of the invention. Where appropriate, these processes may, for example, be implemented completely in the processing circuitry of a user equipment device (e.g., control circuitry 304 of FIG. 3) or may be implemented at least partially in a remote server. It should be understood that the steps of the flow charts are merely illustrative and any of the depicted steps may be modified, omitted, or rearranged, two or more of the steps may be combined, or any additional steps may be added, without departing from the scope of the invention. Also, some of the steps may be executed or performed substantially simultaneously where appropriate or in parallel to reduce latency and processing times.

At step 1002, actuation of the touch-sensitive screen is determined. For example, control circuitry 304 detects that the touch-sensitive screen of device 600 has been actuated. At Step 1004, the type of input that actuated portion of the touch screen is determined. For example, control circuitry 304 determines which type of input the actuated portion of the touch-sensitive screen of device 600 is configured to receive. In the embodiments described in relation to the touch-sensitive device 600 of FIG. 6, there are three types of inputs. The first type of input is a handwriting input. The second type of input is either a navigation input or a selection input. The third type of input is a media asset playback control input.

At step 1010, the first type of input is processed as a handwritten input. For example, control circuitry 304 determines that the actuated portion of the touch-sensitive device 600 is configured to receive the first type of input and accordingly processes the first type of input as handwritten input. Control circuitry 304 converts the handwritten input received in portion 610 of device 600 into a character string using a handwriting recognition software. At step 1012, a command table is queried to determine the command. For example, control circuitry 304 queries command table 700 to identify the media application guidance function specified by handwritten input. At step 1016, a determination is made whether the media asset or channel corresponding to the command is found. For example, control circuitry 304 determines whether a media asset or channel associated with the handwritten input is found. At step 1020, in response to determining that the media asset or channel corresponding to the command is found, the action based on the command is performed. For example, control circuitry 304 performs the identified media guidance application function if the media asset or channel corresponding to the handwritten input is found. At step 1022, in response to determining that the media asset or channel corresponding to the command is not found, a notification that no media asset or channel corresponding to the command is displayed. Control circuitry 304 displays such a notification in the touch-sensitive screen of device 600.

At step 1030, the second type of user input is received. In response to determining that the actuated portion of the touch-sensitive screen of device 600 is a second type of input, control circuitry 304 receives the user input as a second type of user input. At step 1032, it is determined whether the second type of input is a selection input or a navigation input. Control circuitry 304 determines whether the second type of input received in portion 630 is a navigation input or a selection input. At step 1034, in response to the determination that the second type of input is a selection input, a media guide listing is selected. For example, control circuitry 304 selects a media guide listing in response to determining that the second type of input is to select a portion of the media guide displayed in portion 630. At step 1036, in response to determining that the second type of user input is a navigation input, the direction of the navigation input is determined. Control circuitry 304 determines the direction of the navigation input in portion 630. At step 1038, in response to determining that the second type of user input is a navigation input along the first direction, media guide content for an earlier or later time is displayed. For example, once control circuitry 304 determines that the navigation input's direction is left or right, control circuitry 304 displays media guide content for an earlier or later time than the time displayed before the navigation input was received. At step 1040, in response to determining that the second type of user input is a navigation input along the second direction, media guide content for additional content sources is displayed. For example, once control circuitry 304 determines that the navigation input's direction is up or down, control circuitry 304 displays media guide content for higher or lower numbered channels than the channels previously displayed before the navigation input was received.

At step 1050, in response to determining that the touch screen is configured to receive a third type of input, the third type of input is received. For example, control circuitry 304 receives a third type of user input to control playback of the media asset displayed in portion 620 of the touch-sensitive device 600. At step 1052, the user is allowed to control video playback. For example, control circuitry 304 controls the playback of the video of the media asset displayed in portion 620 if control circuitry 304 receives a third type of input to control the playback of the video of the media asset. At step 1054, the user is allowed to control the audio. For example, control circuitry 304 controls the volume of the audio of the media asset displayed in portion 620 if control circuitry 304 receives a third type of input to control the audio of the media asset. At step 1056, the user is allowed to enable full-screen. For example, control circuitry 304 a full-screen display of the media asset displayed in portion 620 if control circuitry 304 receives a third type of input to enable full-screen mode.

It is to be understood that while certain forms of the present invention have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for navigating an interactive media guide on a user equipment comprising a touch sensitive display device, the method comprising:
receiving handwritten input on a first portion of the touch sensitive display device, wherein the first portion of the touch sensitive display device is dedicated to receiving handwritten input;
generating a display of an interactive media guide on a second portion of the touch sensitive display device, wherein the second portion of the touch sensitive display device is dedicated to receiving input from a user indicative of a navigation direction or a selection; and
generating a display of interactive media guide content on the second portion of the touch sensitive display device corresponding to the received handwritten input.

2. The method of claim 1 further comprising generating a display of a media asset on a third portion of the touch sensitive display device.

3. The method of claim 2 further comprising:
receiving user selection of a media listing from the interactive media guide on the second portion of the touch sensitive display device; and
generating a display of a media asset on the third portion of the touch sensitive display device as a result of receiving user selection of a media listing corresponding to the media asset.

4. The method of claim 1 further comprising searching media listings in the interactive media guide, wherein the media listings are searched with the received handwritten input as the search criteria used to initiate the search.

5. The method of claim 4 further comprising generating display of at least one media listing on the second portion of the touch sensitive display device as a result of searching the media listings based on the received handwritten input.

6. The method of claim 1 further comprising processing the received handwritten input to identify a character or a string of characters.

7. The method of claim 6 further comprising cross-referencing a database to identify a media guidance function corresponding to the identified character or string of characters.

8. The method of claim 1 further comprising:
receiving user navigation input on the second portion of the touch sensitive display device corresponding to a first direction; and
modifying the display of the media guide to display content for an earlier or later time period.

9. The method of claim 8 further comprising:
receiving user navigation input on the second portion of the touch sensitive display device corresponding to a second direction; and
modifying the display of the media guide to display content for additional content sources.

10. The method of claim 1 further comprising generating a display of an advertisement on the third portion of the touch sensitive device based on the received handwritten input.

11. A system for navigating an interactive media guide, the system comprising:
a touch sensitive display device and control circuitry coupled to the touch sensitive display device, wherein the control circuitry is configured to:
receive handwritten input on a first portion of the touch sensitive display device, wherein the first portion of the touch sensitive display device is dedicated to receiving handwritten input;
generate a display of an interactive media guide on a second portion of the touch sensitive display device, wherein the second portion of the touch sensitive display device is dedicated to receiving input from a user indicative of a navigation direction or a selection; and
generate a display of interactive media guide content on the second portion of the touch sensitive display device corresponding to the received handwritten input.

12. The system of claim 11, wherein the control circuitry is further configured to generate a display of a media asset on a third portion of the touch sensitive display device.

13. The system of claim 12, wherein the control circuitry is further configured to:
receive user selection of a media listing from the interactive media guide on the first portion of the touch sensitive display device; and
generate a display of a media asset on the third portion of the touch sensitive display device as a result of receiving user selection of a media listing corresponding to the media asset.

14. The system of claim 11, wherein the control circuitry is further configured to search media listings in the interactive media guide, wherein the media listings are searched with the received handwritten input as the search criteria used to initiate the search.

15. The system of claim 14, wherein the control circuitry is further configured to generate display of at least one media listing on the first portion of the touch sensitive display device as a result of searching the media listings based on the received handwritten input.

16. The system of claim 11, wherein the control circuitry is further configured to process the received handwritten input to identify a character or a string of characters.

17. The system of claim 16, wherein the control circuitry is further configured to cross-reference a database to identify a media guidance function corresponding to the identified character or string of characters.

18. The system of claim 11, wherein the control circuitry is further configured to:
receive user navigation input on the second portion of the touch sensitive display device corresponding to a first direction; and
modify the display of the media guide to display content for an earlier or later time period.

19. The system of claim 18, wherein the control circuitry is further configured to:
receive user navigation input on the second portion of the touch sensitive display device corresponding to a second direction; and
modify the display of the media guide to display content for additional content sources.

20. The system of claim 11, wherein the control circuitry is further configured to generate a display of an advertisement on the third portion of the touch sensitive device based on the received handwritten input.

21-30. (canceled)
